(19) United States
(12) Patent Application Publication
(10) Pub. No.: US 2022/0357296 A1
(43) Pub. Date: Nov. 10, 2022

(54) SYSTEM FOR REMOTELY DETECTING MOISTURE, MONITORING AND CONTROLLING REMEDIATION EQUIPMENT

(71) Applicant: Enio M. De Oliveira, Apopka, FL (US)

(72) Inventor: Enio M. De Oliveira, Apopka, FL (US)

(21) Appl. No.: 17/736,903

(22) Filed: May 4, 2022

Related U.S. Application Data
(60) Provisional application No. 63/184,347, filed on May 5, 2021.

(51) Int. Cl. G01N 27/22; G01K 1/04

(52) U.S. Cl. CPC G01N 27/223; G01K 1/045

(57) ABSTRACT

A system for remotely detecting moisture and monitoring remediation equipment includes a master station having a plurality of power outlets, a sensor suite, and controller that communicates wirelessly with external devices. The sensor suite detects humidity, moisture, atmospheric conditions and mold. Each of the outlets are connected to remediation equipment and are remotely controlled by a user interface and system administrator. At least one discrete moisture detector, discrete humidity detector, discrete vibration detector is communicatively linked to the master station. Sensor data is sent to the user interface and system administrator. At least one remotely controlled power outlet is communicatively linked to the master station and is controlled by the user interface and system administrator.

### CROSS-REFERENCE TO RELATED APPLICATIONS

This application claims the benefit of U.S. Application Ser. No. 63/184,347 filed on May 5, 2021, the contents of which are incorporated herein by reference.

### TECHNICAL FIELD

The present invention relates generally to the mold and moisture remediation industry, and more particularly to a system for remotely detecting moisture and monitoring remediation equipment.

### BACKGROUND

The statements in this section merely provide background information related to the present disclosure and may not constitute prior art.

When remediating water damage, one of the initial steps is to introduce dry warm air as soon as possible to remove moisture from the room(s) where the water was found. Depending on the scale of the water intrusion, it may be necessary to run drying equipment continuously for several hours or several days at a time. As such, remediation companies must periodically send technicians to the location in order to check the operating status of the drying equipment.

Such a step is important because in some instances the customer accidentally or purposefully disconnects the noisy drying equipment such as fans or dryers, for example, thus prolonging the remediation process and/or exacerbating the situation. In addition to checking the status of active drying equipment, other devices such as temperature sensors, moisture sensors and mold detection sensors must be checked to ensure the remediation process is working.

Unfortunately, the requirement to repeatedly send a technician to each remediation project to check equipment represents a significant portion of the overall cost of a remediation project. In some cases, homeowners or businesses cannot afford to hire a remediation company and instead live with toxic mold buildup which can cause serious health problems.

Accordingly, it would be beneficial to provide a system for remotely detecting moisture and monitoring different types of remediation equipment in order to reduce or eliminate the drawbacks described above.

### SUMMARY OF THE INVENTION

The present invention is directed to a system for remotely detecting moisture, monitoring and controlling remediation equipment. One embodiment of the present invention can include a master station having a plurality of power outlets along the main body, a sensor suite, and controller that communicates wirelessly with external devices. The sensor suite can include a plurality of sensors capable of detecting humidity, moisture, atmospheric conditions and mold. The controller can send sensor data to an external device such as a user interface or a system administrator.

In one embodiment, remediation equipment can be plugged into each of the power outlets and the operation of the outlets can be remotely controlled by the user interface and system administrator. In one embodiment, the outlets can be automatically transitioned between an ON and OFF operating state based on the sensor data.

In one embodiment, the system can include at least one discrete moisture detector. The moisture detector can be communicatively linked to the master station by a wire or wirelessly, and can transmit moisture sensor data.

In one embodiment, the system can include at least one discrete humidity detector. The humidity detector can be communicatively linked to the master station by a wire or wirelessly, and can transmit humidity sensor data.

In one embodiment, the system can include at least one vibration detector. The vibration detector can be communicatively linked to the master station by a wire or wirelessly, and can be removably connected to a piece of remediation equipment. The vibration detector can transmit a notice to the master station of whether or not the connected remediation equipment is in an ON or OFF operating state based on detected vibrations of the same.

In one embodiment, the system can include at least one remotely controlled power outlet. The outlet can be plugged into a power source at the subject property, can be communicatively linked to the master station, and can selectively supply power to a piece of remediation equipment based on an instruction from the master station.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 shows an exemplary operating environment of a system for remotely detecting moisture, monitoring and controlling remediation equipment according to some embodiments of the technology.

FIG. 2 is an exemplary block diagram of the remote remediation system, in accordance with one embodiment of the invention.

FIG. 3 is a perspective view of the master station of the system for remotely detecting moisture, monitoring and controlling remediation equipment, in accordance with one embodiment of the invention.

FIG. 4 is an exemplary block diagram of the sensor suite of the master station of the system for remotely detecting moisture, monitoring and controlling remediation equipment, in accordance with one embodiment of the invention.

FIG. 5 is an exemplary block diagram of the controller of the master station of the system for remotely detecting moisture, monitoring and controlling remediation equipment, in accordance with one embodiment of the invention.

FIG. 6 is a perspective view of the moisture detector of the system for remotely detecting moisture, monitoring and controlling remediation equipment, in accordance with one embodiment of the invention.

FIG. 7 is a perspective view of the humidity detector of the system for remotely detecting moisture, monitoring and controlling remediation equipment, in accordance with one embodiment of the invention.

FIG. 8 is a perspective view of the vibration detector of the system for remotely detecting moisture, monitoring and controlling remediation equipment, in accordance with one embodiment of the invention.

FIG. 9 is a perspective view of the remote outlet of the system for remotely detecting moisture, monitoring and controlling remediation equipment, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As described herein, the term “system administrator” can be used to describe any individual, group or legal entity that is providing the below described system components and/or overseeing the system for monitoring the same. In one embodiment, the system administrator can be a remediation company, or can be a third-party company providing services to a remediation company for use with their customers.

As described herein, “remediation company” can be any individual, group or legal entity that uses the below described system to perform moisture and/or mold remediation on a subject property such as a home or office, for example.

As described herein, a “unit” means a series of identified physical components which are linked together and/or function together to perform a specified function.

As described herein, the term “removably secured,” and derivatives thereof shall be used to describe a situation wherein two or more objects are joined together in a non-permanent manner so as to allow the same objects to be repeatedly joined and separated.

As described herein, the term “connector” includes any number of different elements that work alone or together to repeatedly join two items together in a nonpermanent manner. Several nonlimiting examples include opposing strips of hook and loop material (i.e. Velcro®), attractively-oriented magnetic elements, flexible strips of interlocking projections with a slider (i.e., zipper), a thin, flexible strap with a notched surface and one end threaded through a locking mechanism (i.e., zip tie) at the other, tethers, buckles such as side release buckles, and compression fittings such as T-handle rubber draw latches, hooks, snaps and buttons, for example. Each illustrated connector and complementary connector can be permanently secured to the illustrated portion of the device via a permanent sealer such as glue, adhesive tape, or stitching, for example.

Although described throughout this document as being used to remediate moisture or mold at a subject property, the inventive concepts are not limited to any particular use or industry.

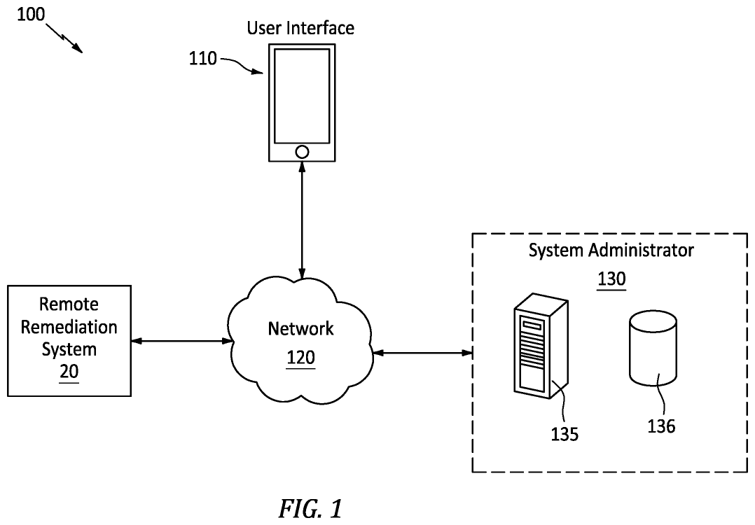

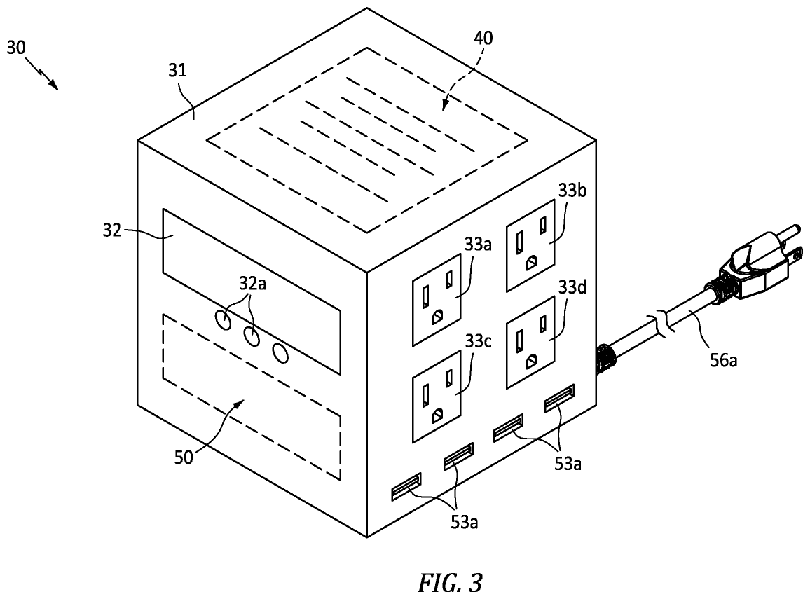

FIGS. 1-9 illustrate one embodiment of a system for remotely detecting moisture, monitoring and controlling remediation equipment that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 3.

FIG. 1 is a schematic illustration of an exemplary operating environment 100 for implementing a system for remotely detecting moisture and monitoring remediation equipment. In one embodiment, the system 100 can include at least one remediation company interface device 110 and at least one remote remediation system 20, that can be connected over a network 120 with a system administration 130.

The network 120 can be any type of network, including a cellular network, local area network (“LAN”), such as an intranet, a wide area network (“WAN”), the internet, and/or any other type of data transmission and reception medium.

The interface device 110 can be any type of computing device that is operable by a human user. A computing device refers to any device with a processor and memory that can execute instructions and communicate with another device. Computing devices include, but are not limited to, smartphones, tablet computers, personal computers, laptop computers and/or purpose-built machines that are pre-encoded with an application interface, so as to perform the functionality so described. In either instance, the computing device can include one or more client applications, such as a conventional web browser, and/or an application interface, for example, which can allow the device to communicate with the system administration 130 and/or the remote remediation system 20.

The system administration 130, according to one embodiment, can include one or more individual computing devices 135 that can be connected to one or more databases 136 on which various portions of the below described methodology can be performed. The system administration 130 can function to provide a central hub for controlling the communication between the interface devices 110 and the remote system 20 through any number of different mediums such as a direct connection (e.g., cellular data), a website, mobile application, secure application or email, for example. In this regard, one or more of the individual computing devices 135 can include various web servers, email servers, application database servers and so forth.

The database 136 can function to store any type of data, including sensor data captured by the remote system, along with operating instructions for facilitating communication between the device components, routing information and/or generating presentation screens for implementing the below described methodology. To this end, the database can include any type of computer-readable storage mediums, including all forms of volatile and non-volatile memory such as, for example, semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD.

As will be described below, the remote remediation system 20 can be deployed at a subject property where remediation services are to be performed. The system 20 perform moisture and/or mold remediation and can be communicatively linked to the remediation company interface device 110 to allow a technician to remotely monitor a plurality of sensors, and to remotely control and monitor the operation of various pieces of remediation equipment.

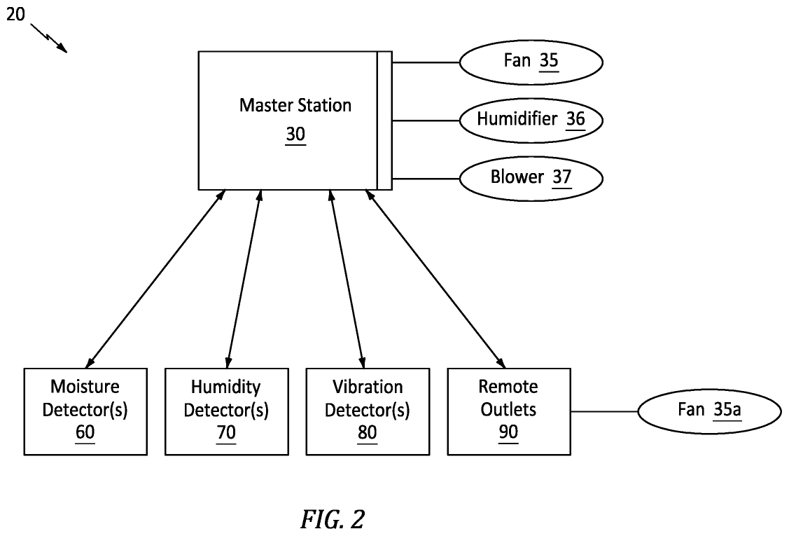

FIG. 2 illustrate one embodiment of a remote remediation system 20. As shown, the system 20 can include a master station 30 that is connected to a plurality of externally located detectors such as one or more moisture detectors 60, humidity detectors 70, vibration detectors 80, and remote power outlets 90, among others, for example. The master station can also be connected to any number of discrete remediation devices such as one or more fans 35, humidifiers 36, and/or hot air blowers 37, among others, for example.

FIG. 3 illustrates one embodiment of the master station 30 which can be positioned at a subject property where services such as mold or moisture remediation are to be performed. The station can function to directly interface with a plurality of discrete sensors and remediation equipment and can control the operation of the same. The station can also send and receive information such as sensor data and operating instructions with the system administrator 130 and/or the user interface device 110, so as to eliminate or reduce the need for a technician to physically visit the subject property during a remediation process.

As described herein, the main body 31 can include any number of different shapes and sizes, and may be formed from materials that are, for example, relatively strong and stiff for their weight. Several nonlimiting examples include but are not limited to various metals or metal alloys (e.g., aluminum, steel, titanium, or alloys thereof), plastic/polymers (e.g., high-density polyethylene (HDPE), rigid polyvinyl chloride (PVC), or polyethylene terephthalate (PET)), and/or various composite materials (e.g., carbon fibers in a polymer matrix, fiberglass, etc.,).

In one embodiment, a control panel 32 can be positioned along the main body 31 and can function to accept user inputs and/or to provide information to an on-site device user. The control panel can be connected to the below described system controller 50 and can include or control one or more buttons/switches 32a, in order to activate various programmatic functions. In various embodiments, the control panel can comprise a touch screen Graphic User Interface (GUI), for example, that is capable of performing two-way communication with a device user.

In one embodiment, a plurality of power supply outlets 33a-33d having an internally located electrical switch can be provided along the main body and can be selectively controlled by the system controller 50. The outlets can be electrically connected to the station's power unit 56 which in turn is connected to the power supply of the subject property via an electrical cord 56a. Remediation equipment such as the illustrated fan 35, humidifier 36 and/or blower 37, among other types of equipment, for example can be plugged into one of the supply outlets.

In operation, the system administrator 130 and/or a user operating the interface device 110 or the control panel 32 can selectively and individually control the operation of each of the outlets 33a-33d between an ON and OFF operating state so as to selectively enable and disable the connected remediation equipment during the remediation procedure.

In one embodiment, a plurality of sensors can be positioned along or within the main body 31. Each of these sensors are referred to collectively as a sensor suite 40 and can function to capture any type of remediation information. The sensor suite 40 can be connected to the controller 50, so as to receive operating instructions therefrom and to allow the information captured by the sensor suite to be stored in the system memory and/or transmitted to the system administrator 130 and the user interface 110

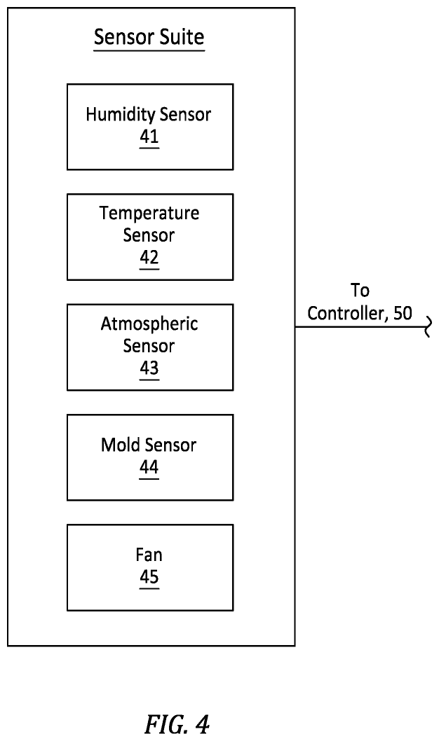

As shown at FIG. 4, one embodiment of a sensor suite 40 for use herein can include a humidity sensor 41, a temperature sensor 42, an atmospheric sensor 43, and/or a mold sensor 44, and among others, for example. The sensor suite can also include or can be connected to a fan 45 for moving air across the sensor surfaces during operation.

The humidity sensor 41 can include any device capable of detecting the presence and amount of humidity in the air. In various embodiments, the humidity sensor can function to detect change that alter electrical currents or temperature in the air and can comprise a capacitive, resistance or thermal-type sensor.

The temperature sensor 42 can include any device capable of detecting the temperature of air in a given space. In various embodiments, the temperature sensor can include a thermocouple or solid-state sensor, among others, for example.

The atmospheric sensor 43 can include any device capable of detecting various atmospheric details. In various embodiments, the atmospheric sensor can include a barometric atmospheric pressure sensor, however other types of sensors are also contemplated.

The mold detection sensor 44 can include any type of device capable of measuring and/or determining the presence of mold particulates in the air. In various embodiments, the mold detection sensor can utilize infrared or laser light to identify the presence of mold particulates in the air; however other means for detecting the presence of mold is also contemplated.

Although described above as including specific components 41-45, this is for illustrative purposes only, as those of skill in the art will recognize that any number of additional sensors/components can be provided in order to capture any type of air quality, air temperature or remediation data.

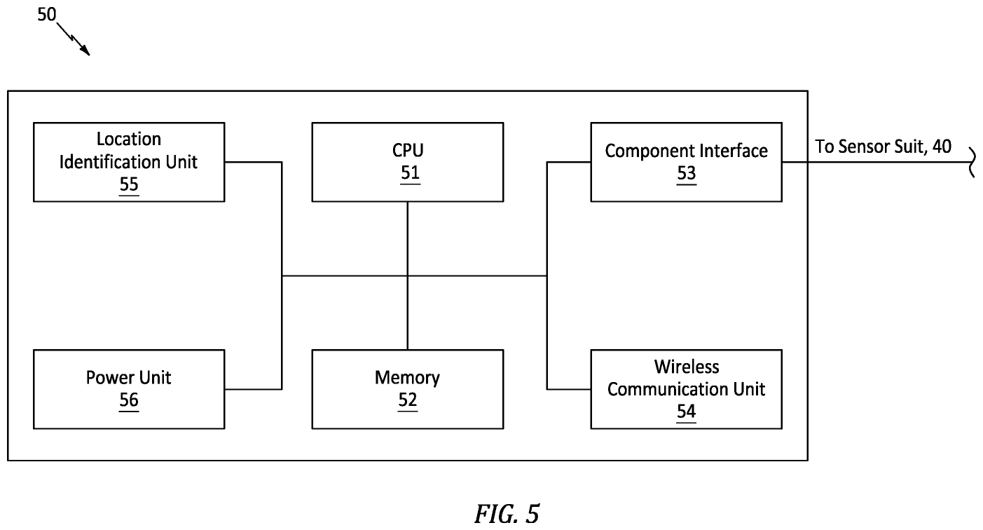

FIG. 5 is a simplistic block diagram illustrating one embodiment of the system controller 50. The controller can be in communication with each of the plurality of external devices 60-90, can control an operation of the onboard sensor suite 40, can control the power outlets 33a-33d, and can communicate wirelessly with the system administrator 130 and/or the user interface 110, among other functions, for example.

One embodiment of the system controller 50 can include a processing unit 51 that is conventionally connected to an internal memory 52, a component interface unit 53, a wireless communication unit 54, a location identification unit 55, and/or a power unit 56.

Although illustrated as separate elements, those of skill in the art will recognize that one or more system components 51-56 may include, comprise, or consist of one or more printed circuit boards (PCB) containing any number of integrated circuit or circuits for completing the activities described herein. The CPU may be one or more integrated circuits having firmware for causing the circuitry to complete the activities described herein. Of course, any number of other analog and/or digital components capable of performing the described functionality can be provided in place of, or in conjunction with the described elements.

The processing unit 51 can include one or more central processing units (CPU) or any other type of device, or multiple devices, capable of manipulating or processing information such as program code stored in the memory 52 in order to allow the device to perform the functionality described herein.

Memory 52 can act to store operating instructions in the form of program code for the processing unit 51 to execute. Although illustrated in FIG. 5 as a single component, memory 52 can include one or more physical memory devices such as, for example, local memory and/or one or more bulk storage devices. As used herein, local memory can refer to random access memory or other non-persistent memory device(s) generally used during actual execution of program code, whereas a bulk storage device can be implemented as a persistent data storage device such as a hard drive, for example.

In various embodiments, the memory can contain any number of different programs that permit the processor to perform the functionality described herein, such as controlling the operation of each element of the sensor suite 40, the power outlets 33a-33d, and the external sensors via the component interface, for example. The memory device can also function to receive and store data from the sensors and detectors.

The component interface unit 53 can function to provide a communicative link between the processing unit 51 and various system elements such as the individual sensors of the sensor suite 40, the power outlets 33a-33d, the communication unit 54, and/or the power unit 56, for example. In this regard, the component interface unit can include any number of different components such as one or more PIC microcontrollers, standard bus, internal bus, connection cables, and/or associated hardware capable of linking the various components.

In one embodiment, the component interface unit can include, or can be connected to a plurality of cable plugs 53a such as USB ports, computer ports, or other such plugs that are capable of engaging a power and/or communication cable connected to the external detectors. Of course, any other means for providing the two-way communication between the system components can also be utilized herein.

The wireless communication unit 54 can include any number of components capable of sending and/or receiving electronic signals with another device, either directly or over a network. In one preferred embodiment, the communication unit 54 can include a cellular communicator/transceiver for communicating wirelessly with an external device such as the user interface 110 and system administrator 130, for example. Such a feature allowing a user to remotely control an operation of the master station 30 and all connected components, along with receiving sensor data from each connected device.

In one embodiment, the communication unit can also include a WiFi transceiver or other such device for performing local wireless communication with system components located at the subject property, such as the external detectors 60-90 described below. Of course, the communication unit is not limited to the use of these particular components, as any number of other transmission and reception mechanisms and protocols can also be utilized herein. Several nonlimiting examples include Bluetooth, Near-Field-Communication (NFC) devices, UHF, and/or radio transmitters and receivers, for example.

The location identification unit 55 can function to provide real time location information (e.g., address, GPS coordinates, etc.) of the master station 20 at all times. In one embodiment, the location module can comprise a discrete GPS signal antenna, and transceiver for communicating with a third-party location tracking company that provides tracking and/or location services for registered GPS enabled devices. Alternatively, or in addition thereto, the location unit can utilize the cellular transceiver of the device to interact with the mapping and location services offered by the cellular provider. In either instance, the captured location information can be determined and stored by the system database for inclusion in a remediation report and/or for insurance auditing purposes.

The power unit 56 can function to supply the required power to each of the system components. In one embodiment, the power unit can include an A/C electrical power transformer and cord 56a capable of allowing the station to be powered from a standard electrical outlet such as a 110- or 220-volt outlet, for example. The power unit can include functionality for directing power to each of the outlets 33a-33d and for each of the system components. In one embodiment, the power source can also include a plurality of onboard batteries which can function to supply power to the system components in the event of a commercial power failure.

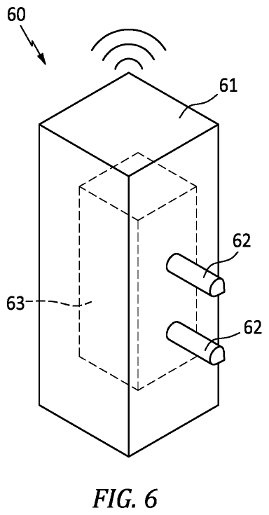

FIG. 6 illustrates one embodiment of a moisture detector 60 which can be communicatively linked to the master station 30. In the illustrated embodiment, the moisture detector can function to detect moisture within a wall and can include a main body 61 having a pair of probes 62 extending outward therefrom. Each of the probes can be connected to an onboard microchip that detects humidity and/or moisture within the wall. An onboard battery and wireless transceiver 63 can communicate the detected sensor readings to the master station 30 for storage and/or transmission to the system administrator and user interface.

Although illustrated with regard to a single wall mounted moisture detector that is in wireless communication with the master station 30, the system is not so limiting. To this end, the system 20 can include any number of different moisture detectors which can be positioned anywhere within the subject property for detecting moisture along or within any surface. One or more of the detectors may be wirelessly connected or may be physically connected to the master station via a communication wire (not illustrated) that is engaged with one of the communication port(s) 53a, for example.

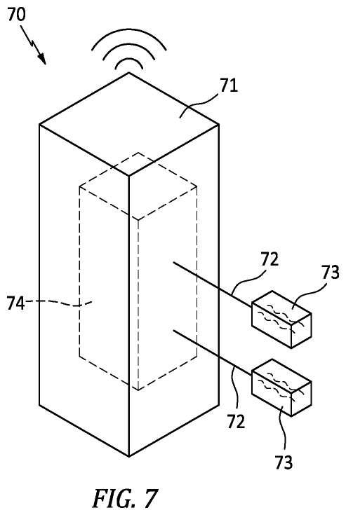

FIG. 7 illustrates one embodiment of a humidity detector 70 which can be communicatively linked to the master station 30. In the illustrated embodiment, the humidity detector can function to detect the humidity level of an area of the subject property and can include a main body 71 having a pair of probes 72 extending outward therefrom. In the preferred embodiment, the humidity detector can be connected to a fan or other air moving device such that one of the probes is positioned at the air intake of the fan and the other is positioned at the air outlet.

Thermocouples 73 located in the probes can function to detect the difference in air temperature and moisture. This information can be sent to an onboard microchip that determines the humidity level and monitors the increase or decrease of the same. An onboard battery and wireless transceiver 74 can communicate the detected sensor readings to the master station 30 for storage and/or transmission to the system administrator and user interface.

Although illustrated with regard to a single humidity detector for use with an air moving device, the system is not so limiting. To this end, the system 20 can include any number of different types of humidity detectors which can be positioned anywhere within the subject property for detecting humidity levels. One or more of the detectors may be wirelessly connected or may be physically connected to the master station via a communication wire (not illustrated) that is engaged with one of the communication port(s) 53a, for example.

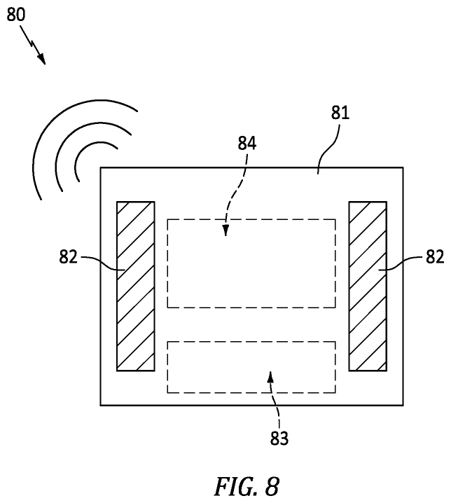

FIG. 8 illustrates one embodiment of a vibration detector 80 which can be communicatively linked to the master station 30. In the illustrated embodiment, the vibration detector can function to detect the vibrations associated with a piece of equipment that is running. For example, the vibrations of a motor spinning a fan blade or humidifier, for example.

In one embodiment, the vibration detector can include a main body 81 having a connector 82 such as adhesive tape or magnets, for example to secure the main body to the external equipment. A vibration sensor 83 such as a solid-state vibration, tilt or omnidirectional orientation sensor can be positioned within the main body and can be connected to an onboard battery and wireless transceiver 84. The transceiver can function to transmit the detected sensor readings to the master station 30 for storage and/or transmission to the system administrator and user interface. The vibration sensor(s) being used to ensure remediation equipment is operating and has not been switched off by an occupant of the subject property.

Although illustrated with regard to a single vibration detector that is in wireless communication with the master station 30, the system is not so limiting. To this end, the system 20 can include any number of different vibration and/or movement detection sensors which can be positioned along any type of different equipment located at the subject property undergoing remediation for detecting operations of the same. One or more of the detectors may be wirelessly connected or may be physically connected to the master station via a communication wire (not illustrated) that is engaged with one of the communication port(s) 53a, for example.

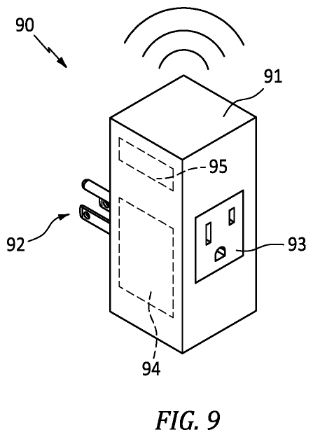

FIG. 9 illustrates one embodiment of a remotely operable outlet 90 which can be communicatively linked to the master station 30. In the illustrated embodiment, the outlet can a main body 91 having a power plug 92 along one end and a power outlet 93 along another end. An internal switch 94 is connected to an onboard processor and transceiver 95 which communicates with the master station. The plug can include any number of prongs for engaging an electrical outlet within the subject property, and the outlet can be connected to the power cable of any type of remediation equipment such as a fan 35a, humidifier, or blower, for example.

The master station 30 can remotely control the internal switch 94 in order to selectively turn the connected piece of equipment ON or OFF depending on a received command from the display 32, system administrator 130 or user interface 110. Of course, the system is not limited to the use of a single remotely operable outlet for controlling remediation equipment, as any number of different outlets can be utilized for controlling any number of different types of equipment.

In operation, the system 20 can be installed at a subject property undergoing mold or moisture remediation. During the installation, the master station 30 can be plugged into an electrical outlet and the wireless transceiver can begin communicating with the system administrator and/or user interface. Next, one or more of the remote detectors 60-90 can be positioned within the subject property, and remediation equipment such as the above-described fans 35, humidifiers 36 and/or hot air blowers 37, for example can be positioned.

In the preferred embodiment, the remediation equipment can be connected to the power outlets 33a-33d or 90, so as to be directly controlled by the master station. Alternatively, or in addition to the above, the vibration detector(s) 80 can be connected to each piece of equipment to ensure notify the remediation company if/when a piece of equipment has been turned off or disconnected during the remediation process.

Once the equipment is setup and running, sensor data can be sent to the system administrator 130 for storage in the database 136 and for inclusion in a remediation report and for insurance auditing. This information can also be monitored by a technician utilizing the user interface device 110 in real time. Additionally, the system administrator and/or a technician can send commands to activate or deactivate equipment connected to the outlets based on a detected event.

For example, if the temperature sensor detects that a blower is overheating, the system administrator can automatically cut power to the equipment to prevent a fire. If a moisture sensor detects moisture, a technician using the user interface device can activate an adjacent blower by turning on the outlet to which it is connected in order to immediately begin remediating the detected moisture. Finally, if the vibration sensor detects that a piece of equipment has stopped running—due to the absence of vibrations—the technician can call or visit the property to determine if it was disconnected by an occupant. Each such instance can also be logged by the system administrator for inclusion in a remediation report and/or insurance audit.

As described herein, one or more elements of the remote remediation system 20 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A system, comprising:
a master station having a main body and a user interface;
at least one electrical outlet that is positioned along the main body;
a sensor suite that is positioned along or within the main body;
a controller that is in communication with each of the user interface, the at least one electrical outlet, and the sensor suite,
wherein the controller is configured to communicate data captured by the sensor suite to an external device.

2. The system of claim 1, wherein the sensor suite includes a humidity sensor.

3. The system of claim 1, wherein the sensor suite includes a temperature sensor.

4. The system of claim 1, wherein the sensor suite includes an atmospheric sensor.

5. The system of claim 1, wherein the sensor suite includes a mold sensor.

6. The system of claim 1, wherein the controller is configured to transition each of the at least one electrical outlet between an ON and OFF operating state.

7. The system of claim 6, further comprising:
a wireless communication unit.

8. The system of claim 7, wherein the wireless communication unit is configured to receive an instruction to selectively transition each of the at least one electrical outlet between the ON and OFF operating state based on an instruction received from the wireless communication unit.

9. The system of claim 6, wherein each of the at least one electrical outlet is configured to selectively supply power to a piece of remediation equipment.

10. The system of claim 9, further comprising:
a wireless communication unit.

11. The system of claim 10, wherein the wireless communication unit is configured to receive an instruction to selectively supply power to the piece of remediation equipment based on an instruction received from the wireless communication unit.

12. The system of claim 1, further comprising:
at least one moisture detector that is communicatively linked to the master station.

13. The system of claim 1, further comprising:
at least one humidity detector that is communicatively linked to the master station.
